(19) United States
(12) Patent Application Publication
(10) Pub. No.: US 2023/0186223 A1
(43) Pub. Date: Jun. 15, 2023

(54) METHOD FOR DETERMINING SPATIAL SERVICE PERFORMANCE OF URBAN PUBLIC WELFARE SERVICE FACILITIES

(71) Applicant: Huazhong University of Science and Technology, Wuhan (CN)

(72) Inventors: Zhuoran Shan, Wuhan (CN); Man Yuan, Wuhan (CN); Junqing Zhu, Meishan (CN); Haolan Pan, Ji'an (CN); Chengkai Liu, Lu'an (CN)

(21) Appl. No.: 17/963,278

(22) Filed: Oct. 11, 2022

(30) Foreign Application Priority Data
Dec. 10, 2021 (CN) 2021115090246

(51) Int. Cl. G06Q 10/06; G06Q 50/22

(52) U.S. Cl. CPC G06Q 10/06395; G06Q 50/22

(57) ABSTRACT

A method for determining spatial service performance of urban public welfare service facilities is provided, in which basic data of the public welfare service facilities in a research area is collected to determine the spatial service basic performance; and a location factor of each of the urban public welfare service facilities is determined according to distances between the urban public welfare service facility and various urban centers, and finally the spatial service performance of the urban public welfare service facilities of the whole research area is determined. The method is simple in process, amount of the data is small and the data is convenient to collect. The data is collected from core business data of a natural resources and planning department, and thus the spatial data of various types of public welfare service facilities can be determined stably.

### TECHNICAL FIELD

The present disclosure relates to the field of land resource management and urban planning, and more particularly to a method for determining spatial service performance of urban public welfare service facilities.

### DESCRIPTION OF RELATED ART

Urban public welfare service facilities are non-profit or not for profit purposes, and are intended to meet daily requirements of urban residents, embody social fairness and justice, and realize equalization of basic public interests, which include urban public service facilities practically related to interests of the urban residents such as education, culture, sports, medical and health, and social welfare. At present, social economy is in a high-quality development stage, and requirements and demands of the urban residents on quantity, quality and scale of the public welfare service facilities are constantly increasing. However, problems of poor service radius, low frequency of use, low supply efficiency and large regional differences of urban public welfare service facilities become increasingly prominent. How to improve service quality and level of the urban public welfare service facilities has become an urgent problem to be solved. Based on huge service efficiency of the urban public welfare service facilities, spatial service performance of each of the urban public welfare service facilities means the ability of serving the urban residents in the spatial dimension of the urban public welfare service facilities.

Determining of the spatial service performance of the urban public welfare service facilities refers to quantification of service quality and level of the urban public welfare service facilities in a certain period of time. Existing evaluation practice and related research results of the spatial service performance of the urban public welfare service facilities focus on single facility such as culture, education, health, sports, a green space, or single building such as a library, a primary or secondary school, and a health service station, and methods such as data envelopment analysis (DEA), analytic hierarchy process (AHP), key performance indicators, balanced scorecard and the like are used to evaluate and analyze an efficiency of the urban public welfare service facilities. In the methods, selection of the indicators relates to social attributes of the urban public welfare service facilities, and corresponding evaluation indicator systems are designed based on specific contents such as a project planning, project implementation, process management, input and output, service effect and masses satisfaction. For example, in order to meet requirements of society and supply of government public goods, dozens of indicators are selected to evaluate the spatial service performance from various dimensions such as government education, government social security, government public health, government public utilities, etc. Specifically, indicators for the government education include adult illiteracy rates, middle school enrollment rates, gross enrollment rates of universities, etc. The above evaluation indicator systems are complex, and usually involve business data and Internet data of different government departments. The required amount of data is large, but the data is difficult to obtain and update. Moreover, selections of evaluation indicators for various types of public welfare service facilities are quite different, so that it is difficult to carry out integrated calculation and thus it is not suitable for quantitative research on the spatial service performance of diversified public welfare service facilities.

### SUMMARY

In view of the above defects or improvement requirements of the related art, the present disclosure provides a method for determining spatial service performance of urban public welfare service facilities, thereby solving the technical problem that it is difficult to determine the spatial service performance of the urban public welfare service facilities.

In order to achieve the above objective, according to a first aspect of the present disclosure, a method for determining spatial service performance of urban public welfare service facilities is provided, which may include: step S1, determining spatial service basic performance U_{basic} of each of the urban public welfare service facilities according to a gross floor area S_{GFA} and a land area S_{land} of the urban public welfare service facility, wherein U_{basic} = S_{land}^{α} * S_{GFA}^{b} , α indicates output elasticity of the land area, and b indicates output elasticity of the gross floor are; step S2, determining a center location coefficient k of each of the urban public welfare service facilities according to distances between the urban public welfare service facility and various urban centers; step S3, determining a location factor L of each of the urban public welfare service 1-c facilities according to an expression of

$$L = \frac{1 - c}{1 + {e}^{t \left(\frac{2 r}{D} - 1\right)}} + c + k ,$$

where r indicates a distance between the urban public welfare service facility and the urban center to which the urban public welfare service facility belongs, c indicates a marginal density, t indicates a slope parameter, k indicates the center location coefficient, and D indicates a region radius; and; and step S4, determining, based on the spatial service basic performance U_{basic} and the location factor L, the spatial service performance U of each of the urban public welfare service facilities according to an expression of U = U_{basic} * L.

In a preferred embodiment, the method may further include: determining spatial service performance U′ of the urban public welfare service facilities according to an expression as m follows:

$$U \text{} {}_{}^{‵}{=} {\sum }_{i}^{m} {U}_{i} * {W}_{i} ,$$

where, m indicates a total number of the urban public welfare service facilities, Uᵢ indicates the spatial service performance of an i-th urban public welfare service facility of the urban public welfare service facilities, Wᵢ indicates a weight of the i-th urban public welfare service facility, and i is a positive integer.

In a preferred embodiment, the output elasticity α of the land area is determined according to an expression of

$$a = \frac{1}{\left(1 + F A R\right)} ,$$

and the output elasticity b of the gross floor area is determined according to an expression of

$$b = \frac{F A R}{\left(1 + F A R\right)} ,$$

where FAR indicates a floor area ratio.

In a preferred embodiment, each of the urban public welfare service facilities comprises a public welfare service facility corresponding to one of four types of land, and the four types of land respectively are: a A-type of land being a public management and public service land, a S-type of land being a road and traffic facilities land, a U-type of land being a public facilities land, and a G-type of land being a green space and square land.

In a preferred embodiment, the determining a center location coefficient k of each of the urban public welfare service facilities according to distances between the urban public welfare service facility and various urban centers, specifically comprises: determining a center type of the urban center to which the urban public welfare service facility belongs according to the distances between the urban public welfare service facility and the various urban centers, and determining the center location coefficient k of the urban public welfare service facility according to the center type.

In a preferred embodiment, the center type is one of an urban main center, an urban sub-center, and an urban new center.

In a preferred embodiment, k=1, when the center type of the urban center to which the urban public welfare service facility belongs is the urban main center; k=0.8, when the center type of the urban center to which the urban public welfare service facility belongs is the urban sub-center; k=0.6, when the center type of the urban center to which the urban public welfare service facility belongs is the urban new center.

According to a second aspect of the present disclosure, a device for determining spatial service performance of urban public welfare service facilities is provided, including a processor and a memory coupled to the processor; where the memory is stored with software modules executable by the processor, and the software modules includes: a spatial service basic performance determining module, configured to determine spatial service basic performance U_{basic} of each of the urban public welfare service facilities according to a gross floor area S_{GFA} and a land area S_{land} of the urban public welfare service facility, wherein U_{basic} = S_{land}^{α} * S_{GFA}^{b} , α indicates output elasticity of the land area, and b indicates output elasticity of the gross floor area; a center location coefficient determining module, configured to determine a center location coefficient k of each of the urban public welfare service facilities according to distances between the urban public welfare service facility and various urban centers; a location factor determining module, configured to determine a location factor L of each of the 1-c urban public welfare service facilities according to an expression of

$$L = \frac{1 - c}{1 + {e}^{t \left(\frac{2 r}{D} - 1\right)}} + c + k ,$$

where r indicates a distance between the urban public welfare service facility and the urban center to which the urban public welfare service facility belongs, c indicates a marginal density, t indicates a slope parameter, k indicates a location coefficient of the urban center, and D indicates a region radius; and a spatial service performance determining module, configured to determine, based on the spatial service basic performance U_{basic} and the location factor L, the spatial service performance U of each of the urban public welfare service facilities according to an expression of U = U_{basic} * L.

In summary, compared with the related art, the above technical solutions conceived by the present disclosure may at least achieve the following beneficial effects.

According to the method for determining spatial service performance of urban public welfare service facilities, basic data of the public welfare service facilities in a research area is collected to determine the spatial service basic performance of the urban public welfare service facility; and the location factor of the urban public welfare service facility is determined according to the distance between the urban public welfare service facility and a center to which the urban public welfare service facility belongs, and finally the spatial service performance of the urban public welfare service facility of the whole research area is determined. The method is simple in process, amount of the data is small and the data is convenient to collect. The data is collected from core business data of a natural resources and planning department, and thus the spatial data of various types of public welfare service facilities can be determined stably. Further, the corresponding model has strong generalization ability and a measurement scale is flexible. The method can be applied to all kinds of urban public welfare service facilities. The determining of spatial service performance of multi-spatial scale facilities can be realized, and thus integration of spatial service performance of diversified public welfare service facilities can be realized. According to the determined performance, urban public resources can be optimally allocated, and it is convenient for managers to adjust management measures in time.

### BRIEF DESCRIPTION OF DRAWINGS

FIG. 1 illustrates a flow chart of a method for determining spatial service performance of urban public welfare service facilities according to an embodiment of the present disclosure.

FIG. 2 illustrates a schematic view of basic data of urban public welfare service facilities according to an embodiment of the present disclosure.

FIG. 3 illustrates a schematic view of location factors according to an embodiment of the present disclosure.

### DETAILED DESCRIPTION OF EMBODIMENTS

In order to make objects, technical solutions and advantages of the present disclosure clearer and easier to be understood, the present disclosure is described in further detail hereinafter in combination with accompanying drawings and embodiments. It should be understood that the specific embodiments described herein are intended merely to explain the present disclosure but not intended to limit the present disclosure. Furthermore, technical features involved in the embodiments of the present disclosure described below can be combined with each other as long as there is no conflict among them.

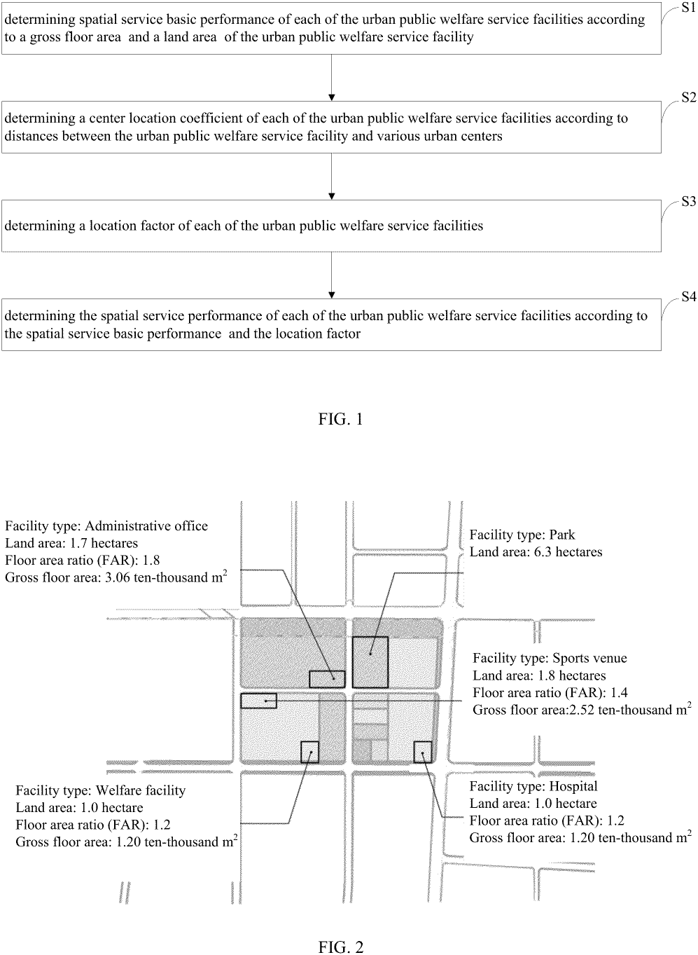

An embodiment of the present disclosure provides a method for determining spatial service performance of urban public welfare service facilities, shown in FIG. 1 and including steps S1 to S4.

In the step S1, spatial service basic performance U_{basic} of each of the urban public welfare service facilities is determined according to a gross floor area S_{GFA} and a land area S_{land} of the urban public welfare service facility, where U_{basic} = S_{land}^{α} * S_{GFA}^{b}, α indicates output elasticity of the land area, and b indicates output elasticity of the gross floor area.

In an embodiment, before the step S1, the method may further include collecting data. Specifically, basic data of the urban public welfare service facilities, mainly including a facility type, facility spatial distribution data, a land area and a gross floor area, a floor area ratio, year of build; and vector data of sphere of influence of various urban centers is collected.

The spatial service basic performance of the urban public welfare service facility is evaluated based on a Cobb-Douglas production function. The Cobb-Douglas production function is used to determine an impact of a capital input and a labor input on an output, and also used to determine contribution of technological progress, capital growth and labor growth to output growth. The Cobb-Douglas production function is imitated, and the gross floor area, the land area and a location factor of the urban public welfare service facility are used as function input parameters to determine the spatial service basic performance.

Further, the output elasticity α of the land area may be determined according to an expression

$$\text{of} a = \frac{1}{\left(1 + F A R\right)} ;$$

and the output elasticity of the gross floor area b may be determined according to an expression of

$$b = \frac{F A R}{\left(1 + F A R\right)} ,$$

where FAR indicates a floor area ratio.

In the step S2, a center location coefficient k of each of the urban public welfare service facilities is determined according to distances between the urban public welfare service facility and various urban centers.

In an embodiment, in the step S2, a center type of the urban center to which the urban public welfare service facility belongs is first determined according to the distances between the urban public welfare service facility and the various urban centers, and then the center location coefficient k of the urban public welfare service facility is determined according to the center type.

In an embodiment, the center type is one of an urban main center, an urban sub-center, and an urban new center.

Further, k=1, when the center type of the urban center to which the urban public welfare service facility belongs is the urban main center; k=0.8, when the center type of the urban center to which the urban public welfare service facility belongs is the urban sub-center; k=0.6, when the center type of the urban center to which the urban public welfare service facility belongs is the urban new center.

In the step S3, a location factor L of each of the urban public welfare service facilities is 1-c determined according to an expression of

$$L = \frac{1 - c}{1 + {e}^{t \left(\frac{2 r}{D} - 1\right)}} + c + k ,$$

where r indicates a distance between the urban public welfare service facility and the urban center to which the urban public welfare service facility belongs, c indicates a marginal density, t indicates a slope parameter, k indicates the center location coefficient, and D indicates a region radius

Specifically, the vector data of sphere of influence of the various urban centers and the facility spatial distribution data of the urban public welfare service facilities are spatially overlaid to determine a result, the center type and the center location coefficient of the urban public welfare service facilities are determined based on the determined result, then the distance between each of the urban public welfare service facilities and the urban center to which the urban public welfare service facility belongs is measured, and finally the location factor is determined according to the center type, the center location coefficient, and the distance.

In the step S4, the spatial service performance U of each of the urban public welfare service facilities is determined based on the spatial service basic performance U_{basic} and the location factor L, and according to an expression of U = U_{basic} * L.

Further, the method may include determining spatial service performance U′ of the urban m public welfare service facilities according to an expression of

$$U \text{} {}_{}^{‵}{=} {\sum }_{i}^{m} {U}_{i} * {W}_{i} ,$$

where, m indicates a total number of the urban public welfare service facilities, Uᵢ indicates the spatial service performance of an i-th urban public welfare service facility of the urban public welfare service facilities, Wᵢ indicates a weight of the i-th urban public welfare service facility, and i is a positive integer.

Specifically, spatial service performance of single facility or similar facility is determined according to an expression as follows: U = U_{basic} * L.

The spatial service performance of the urban public welfare service facilities is determined m according to an expression as follows:

$$U \text{} {}_{}^{‵}{=} {\sum }_{i}^{m} {U}_{i} * {W}_{i} = \sum {U}_{\text{basic}} * L * W ,$$

where Wᵢ indicates the weight of the i-th urban public welfare service facility. The corresponding weight is determined by taking a reciprocal of a per capita land use standard of a corresponding one of the urban public welfare service facilities.

Furthermore, the urban public welfare service facilities includes a public welfare service facility corresponding to one of four types of land, and the four types of land respectively are: a A-type of land being a public management and public service land, a S-type of land being a road and traffic facilities land, a U-type of land being a public facilities land, and a G-type of land being a green space and square land.

A following specific example is used to explain the method for determining the spatial service performance of the urban public welfare service facilities according to the present disclosure. A part of an urban development area of an urban as an example, as shown in FIG. 2.

In step 1, Data (shp (ESRI Shapefile)) with respect to the urban public welfare service facilities is collected from core business data of a natural resources and planning department, including a facility type, facility spatial distribution data, a land area and a gross floor area, a floor area ratio, year of build, as shown in Table 1. Vector data of sphere of influence of the various urban centers of the urban is further collected, including spatial distribution and sphere of influence data of the various urban centers of the urban.

TABLE 1

| Facility type | Land area / hectares (ha) | Gross floor area/ ten-thousand square meters (m²) | Floor area ratio | year of build |
|---|---|---|---|---|
| Administrative office | 1.7 | 3.06 | 1.8 | 2013 |
| Welfare facility | 1.0 | 1.20 | 1.2 | 2015 |
| Park | 6.3 | / | / | 2010 |
| Sports venue | 1.8 | 2.52 | 1.4 | 2015 |
| Hospital | 1.0 | 1.20 | 1.2 | 2010 |

In step 2, spatial service basic performance of each of the urban public welfare service facilities is determined, including following sub-steps (1) and (2).

(1) The output elasticity α of the land area and the output elasticity b of the gross floor area corresponding to each of the urban public welfare service facilities are determined according to following expressions:

$$a = \frac{1}{\left(1 + F A R\right)}$$

$$b = \frac{F A R}{\left(1 + F A R\right)} .$$

(2) The spatial service basic performance U_{basic} of each of the urban public welfare service facilities is determined according to an following expression:

$${U}_{b a s i c} = {S}_{l a n d} {}^{a} * {S}_{G F A} {}^{b} .$$

Further, for the purpose of the calculation convenience, when the park, the sports venue and other facilities have no building area or a floor area ratio of each of them is small, an assignment method is adopted therefor. In this embodiment, the floor area ratio is set to be 0.3.

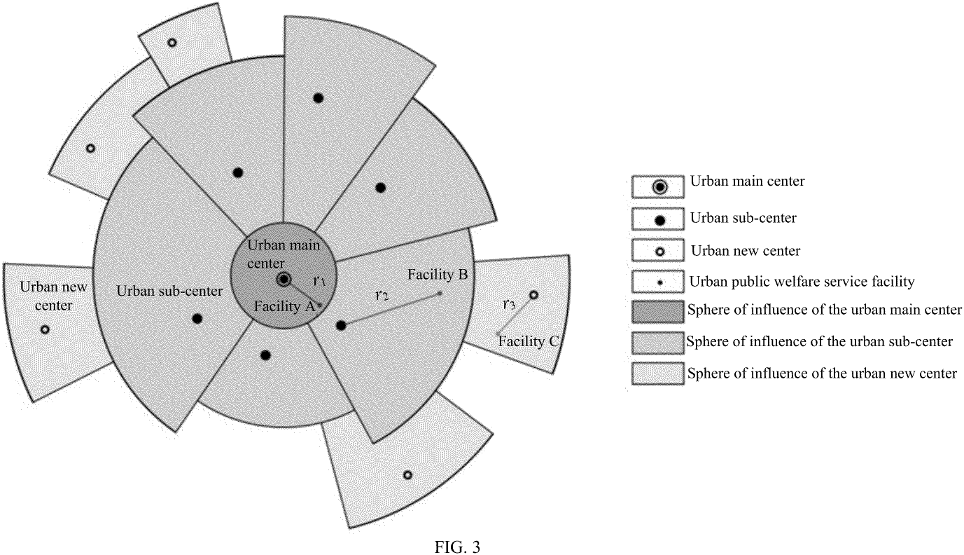

In step 3, a location factor of each of the urban public welfare service facilities is determined. As shown in FIG. 3, the vector data of sphere of influence of the urban centers as a base layer and the facility spatial distribution data of the urban public welfare service facilities as a overlying layer are spatially overlaid to determine a result, a center type and a center location coefficient of each of the urban public welfare service facilities are determined based on the determined result, then a distance between each of the urban public welfare service facilities and the center to which the urban public welfare service facility belongs is measured through a geographic information system (GIS) distance measurement service, and finally the location factor is determined according to the center type, the center location coefficient, and the distance. The location factor is determined according to an expression as follows:

$$L = \frac{1 - c}{1 + {e}^{t \left(\frac{2 r}{D} - 1\right)}} + c + k .$$

Specifically, in this embodiment, the center location coefficient k of the urban main center is set to be 1, the center location coefficient k of the urban sub-center is set to be 0.8, and the center location coefficient k of the urban new center is set to be 0.6. For the purpose of calculation convenience, it is assumed that all facilities are located in the sphere of influence of the urban main center; the slope parameter t is set to be 2.965; the marginal density c is set to be 0.04, and the region radius is set to be 10 kilometers (KM). The distance between each urban public welfare service facility and the center to which the urban public welfare service facility belongs is measured through the GIS distance measurement service, and the measurement results therefor are shown in Table 2.

TABLE 2

| Facility type | Center type of Facility | Distance between the facility and the center to which the facility belongs / KM |
|---|---|---|
| Administrative office | Urban main center | 1.83 |
| Welfare facility | Urban main center | 2.63 |
| Park | Urban main center | 2.68 |
| Sports venue | Urban main center | 2.46 |
| Hospital | Urban main center | 1.97 |

In step 4, spatial service performance of the urban public welfare service facilities is m determined according to an expression of

$$U \text{} {}_{}^{‵}{=} {\sum }_{i}^{m} {U}_{i} * {W}_{i} ,$$

where m indicates a total number of the urban public welfare service facilities, Uᵢ indicates the spatial service performance of an i-th urban public welfare service facility of the urban public welfare service facilities, Wᵢ indicates a weight of the i-th urban public welfare service facility, and i is a positive integer. The corresponding weight is determined by taking a reciprocal of a per capita land use standard of a corresponding one of the urban public welfare service facilities. The smaller the weight, the larger the per capita land use standard (also referred to as per capita required facility area). For the purpose of calculation convenience, weights of facilities are set artificially: the weight of the administrative office is set to be 5.8, the weight of the welfare facility is set to be 7.8, the weight of the park is set to be 1, the weight of the sports venue is set to be 10, and the weight of the hospital is set to be 7.8. The determined U′is equal to 1071569.568.

A device for determining spatial service performance of urban public welfare service facilities according to an embodiment of the present disclosure will be described hereinafter, and the device for determining spatial service performance of the urban public welfare service facilities described below and the method for determining spatial service performance of the urban public welfare service facility described above can be mutually referenced.

The device for determining spatial service performance of urban public welfare service facilities according to the embodiment of the present disclosure may include:

a spatial service basic performance determining module, configured to determine spatial service basic performance U_{basic} of each of the urban public welfare service facilities according to a gross floor area S_{GFA} and a land area S_{land} of the urban public welfare service facility, wherein U_{basic} = S_{land}^{α} * S_{GFA}^{b}, α indicates output elasticity of the land area, and b indicates output elasticity of the gross floor area;

a center location coefficient determining module, configured to determine a center location coefficient k of each of the urban public welfare service facilities according to distances between the urban public welfare service facility and various urban centers;

a location factor determining module, configured to determine a location factor L of each of the urban public welfare service facilities according to an expression of

$$L = \frac{1 - c}{1 + {e}^{t \left(\frac{2 r}{D} - 1\right)}} + c + k ,$$

where r indicates a distance between the urban public welfare service facility and the urban center to which the urban public welfare service facility belongs, c indicates a marginal density, t indicates a slope parameter, k indicates a location coefficient of the urban center, and D indicates a region radius; and

a spatial service performance determining module, configured to determine, based on the spatial service basic performance U_{basic} and the location factor L, the spatial service performance U of each of the urban public welfare service facilities according to an expression of U = U_{basic} * L.

In an exemplary embodiment, the spatial service basic performance determining module, the center location coefficient determining module, the location factor determining module, and the spatial service performance determining module are software modules stored in a memory and executable by a processor coupled to the memory.

In addition, in another exemplary embodiment, the device for determining spatial service performance of urban public welfare service facilities may further include: an applying module, configured to apply the spatial service performance U of each of the urban public welfare service facilities to optimize allocation of urban public resources; and moreover, the applying module may be a software module stored in the memory and executable by the processor coupled to the memory.

Those skilled in the art can easily understand that the above embodiments are merely preferred embodiments of the present disclosure, and are not intended to limit the present disclosure. Any modification, equivalent substitution and improvement made within spirit and principle of the present disclosure should be included in the scope of protection of the present disclosure.

What is claimed is:

1. A method for determining spatial service performance of urban public welfare service facilities, comprising:
step S1, determining spatial service basic performance U_{basic} of each of the urban public welfare service facilities according to a gross floor area S_{GFA} and a land area S_{land} of the urban public welfare service facility, wherein U_{basic} = S_{land}^{a} * S_{GFA}^{b} , a indicates output elasticity of the land area, and b indicates output elasticity of the gross floor area;
step S2, determining a center location coefficient k of each of the urban public welfare service facilities according to distances between the urban public welfare service facility and various urban centers;
step S3, determining a location factor L of each of the urban public welfare service facilities 1-c according to an expression of
$$L = \frac{1 - c}{1 + {e}^{t \left(\frac{2 r}{D} - 1\right)}} + c + k ,$$
^{L} = - ^{+ c} ⁺ ^{K, k} where r indicates a distance between the 1+e ^{D} urban public welfare service facility and the urban center to which the urban public welfare service facility belongs, c indicates a marginal density, t indicates a slope parameter, k indicates the center location coefficient, and D indicates a region radius; and
step S4, determining, based on the spatial service basic performance U_{basic} and the location factor L, the spatial service performance U of each of the urban public welfare service facilities according to an expression of U = U_{basic} * L .

2. The method for determining the spatial service performance of the urban public welfare service facilities according to claim 1, further comprising:
determining spatial service performance U′ of the urban public welfare service facilities according to an expression as follows:
$$U = {\sum }_{i}^{m} {U}_{i} * {W}_{i} ,$$
where, m indicates a total number of the urban public welfare service facilities, Uᵢ indicates the spatial service performance of an i-th urban public welfare service facility of the urban public welfare service facilities, Wᵢ indicates a weight of the i-th urban public welfare service facility, and i is a positive integer.

3. The method for determining the spatial service performance of the urban public welfare service facilities according to claim 1, wherein the output elasticity a of the land area is determined according to an expression of
$$a = \frac{1}{\left(1 + F A R\right)} ,$$
1 (₁ ₊ _{FAR)}, and the output elasticity b of the gross floor area is determined according to an expression of
$$b = \frac{F A R}{\left(1 + F A R\right) ,}$$
= F′l+FAR), where FAR indicates a floor area ratio.

4. The method for determining the spatial service performance of the urban public welfare service facilities according to claim 1, wherein each of the urban public welfare service facilities comprises a public welfare service facility corresponding to one of four types of land, and the four types of land respectively are: a A-type of land being a public management and public service land, a S-type of land being a road and traffic facilities land, a U-type of land being a public facilities land, and a G-type of land being a green space and square land.

5. The method for determining the spatial service performance of the urban public welfare service facilities according to claim 1, wherein the determining a center location coefficient k of each of the urban public welfare service facilities according to distances between the urban public welfare service facility and various urban centers, specifically comprises:
determining a center type of the urban center to which the urban public welfare service facility belongs according to the distances between the urban public welfare service facility and the various urban centers, and determining the center location coefficient k of the urban public welfare service facility according to the center type.

6. The method for determining the spatial service performance of the urban public welfare service facilities according to claim 5, wherein the center type is one of an urban main center, an urban sub-center, and an urban new center.

7. The method for determining the spatial service performance of the urban public welfare service facilities according to claim 6, wherein k=1, when the center type of the urban center to which the urban public welfare service facility belongs is the urban main center;
k=0.8, when the center type of the urban center to which the urban public welfare service facility belongs is the urban sub-center;
k=0.6, when the center type of the urban center to which the urban public welfare service facility belongs is the urban new center.

8. The method for determining the spatial service performance of the urban public welfare service facilities according to claim 1, further comprising:
applying the spatial service performance U of each of the urban public welfare service facilities to optimize allocation of urban public resources.

9. The method for determining the spatial service performance of the urban public welfare service facilities according to claim 1, wherein before the step S1, the method further comprises:
collecting basic data of the urban public welfare service facilities, and vector data of sphere of influence of the various urban centers.

10. A device for determining spatial service performance of urban public welfare service facilities, comprising: a processor and a memory coupled to the processor; wherein the memory is stored with software modules executable by the processor, and the software modules comprise:
a spatial service basic performance determining module, configured to determine spatial service basic performance U_{basic} of each of the urban public welfare service facilities according to a gross floor area S_{GFA} and a land area S_{land} of the urban public welfare service facility, wherein U_{basic} = S_{land}^{a} * S_{GFA}^{b}, a indicates output elasticity of the land area, and b indicates output elasticity of the gross floor area;
a center location coefficient determining module, configured to determine a center location coefficient k of each of the urban public welfare service facilities according to distances between the urban public welfare service facility and various urban centers;
a location factor determining module, configured to determine a location factor L of each of the urban public welfare service facilities according to an expression of
$$L = \frac{1 - c}{1 + {e}^{t \left(\frac{2 r}{D} - 1\right)}} + c + k ,$$
where r indicates a distance between the urban public welfare service facility and the urban center to which the urban public welfare service facility belongs, c indicates a marginal density, t indicates a slope parameter, k indicates a location coefficient of the urban center, and D indicates a region radius; and
a spatial service performance determining module, configured to determine, based on the spatial service basic performance U_{basic} and the location factor L, the spatial service performance U of each of the urban public welfare service facilities according to an expression of U = U_{basic} * L .
